(19) United States
(12) Patent Application Publication
(10) Pub. No.: US 2012/0234474 A1
(43) Pub. Date: Sep. 20, 2012

(54) Bonding method of row bars

(75) Inventor: Ning Li, DongGuan (CN)

(73) Assignee: SAE Technologies Development (Dongguan) Co., Ltd., DongGuan (CN)

(21) Appl. No.: 13/067,793

(22) Filed: Jun. 27, 2011

(30) Foreign Application Priority Data
Mar. 17, 2011 (CN) 201110065096.6

(51) Int. Cl. B29C 65/02

(52) U.S. Cl. 156/212

(57) ABSTRACT

A bonding method of row bars comprises step (1), attaching a flexible member on a flat bottom surface of a pressurized member; step (2), applying a wax layer on a support surface of a support device; step (3), disposing a row bar on the support surface with the wax layer; and step (4), controlling the pressurized member to fall down, so as to press and even out the row bar. The present invention can make the row bar obtain a desired bending degree that is beneficial to the subsequent lapping process, and in turn, improve the quality of the sliders produced from the row bar, and finally improve the read/write performance of the sliders.

### FIELD OF THE INVENTION

The present invention relates to a method for manufacturing sliders used in disk drive unit, and more particularly to a method for bonding a row bar for slider onto a support device, so as to be beneficial to perform the subsequent lapping process.

### BACKGROUND OF THE INVENTION

Hard disk drive incorporating rotating magnetic disks is commonly used for storing data in the magnetic media formed on the disk surfaces, and a magnetic recording head are used in hard disk drive to magnetically record information on a rotating disk.

At present, a method of manufacturing sliders generally comprises step of: (1) cutting a wafer into a plurality of row bars; (2) bonding the row bars on a support device; (3) surface processing (such as lapping) and shaping (such as forming crown) the row bars; (4)bonding the row bars together by epoxy, placing the bonded row bar on a jip and then forming patterns on the row bar; (5) solving the epoxy on the row bar and the jip by solvent, such as NMP (N-Methyl Pyrrolidone), to debond the row bars; (6) cutting the debonded row bar into a plurality of individual slider bodies and finally surface-handling the slider bodies to form the desired sliders.

The following shows a more detailed explanation of why and how the row bar is bonding on the support device. Firstly, as shown in FIG. 1a, a row bar 101 is generated by cutting a quadrate block 102 which is cut down from a wafer 100 into bars. After cut from the block 102, it's inevitable that the row bar 101 presents bend for the reason of the internal stress, as shown in FIG. 1b. As know, the bending row bar 101 will make the lapping process become difficult, and the lapping quantity of each portion of the row bar 101 different, which affects the magnetoresistive (MR) height of slider in the row bar 101, and in turn, affects the performance of the slider finally. Therefore, the step (2) of bonding the row bar 101 on a support device mentioned above is quite important to the subsequent lapping process. FIG. 2 shows a row bar bonding apparatus 2 with a support device 200. The support device 200 includes a base 201 and a supporting step 202 formed thereon, a support surface 203 of the supporting step 202 is arranged to hold the row bar 101. A glue layer 210 is applying on the support surface 203 for bonding the row bar 101.

However, a further internal stress of the row bar 101 will be generated going with the strong instantaneous coagulation of the glue, which causes the shape change of the row bar 101 much complicated, even deform the body of the row bar 101.

In order to solve these problems, another row bar bonding apparatus 2′ and another method is used to even out the bending row bars. As shown in FIG. 3, the row bar bonding apparatus 2′ adds a pressurized block 220 for exerting a force on the row bar 101, comparing with the previous apparatus 2. The pressurized block 220 is hard and has a flat contact surface 221, so as to even out the bending row bars with a pressure. However, on the one hand, the contact surface 221 is hard, and the coagulation force of the glue is quite strong; the contact surface 221 of the pressurized block 220 and the support surface 203 of the support device 200 are hard to be controlled on the other hand, thus, it's hardly to control the bending degree of the row bar 101 within 0.15 um. That is, an undesired bending degree of the row bar 101 is still obtained by this method.

Additionally, yet a method for improving the bending degree for the row bar presents. Firstly, cut a multiple-layer wafer into quadrate blocks by wheels, such as ten layers. Secondly, bond the blocks with multiple layers onto a support device, and perform the lapping process on the upper layer of the block. Finally, cut the upper layer after lapped into multiple individual row bars. Redo the lapping and the cutting process on each lower layer of the block, until every layer of block is cut into row bars. As the upper layer is supported by the lower layers, and the block with multiple layers is bonded to a support device, thus the internal press of the upper layer of block is reduced when cutting the upper layer into row bars. Thus, the upper layer of the row bar has a little bending. However, this advantage only exists on the upper layers except the last lower layer. At the last lower layer of the block, there is no layer supported thereon, that is, when the block with single layer is bonded on the support device, a serious bending of the block still happens, and a bending row bar is obtained after cut.

Therefore, how to improve the bending degree of the row bars so as to obtain a good performance of the slider is still an issue nowadays.

Hence, providing an improved bonding method of row bars to overcome the disadvantages mentioned above is necessary.

### SUMMARY OF THE INVENTION

Accordingly, one aspect of the present invention is to provide a bonding method of row bars, which can obtain a desired bending degree for the row bar that is beneficial to the subsequent lapping process, and in turn, improve the quality of the sliders produced from the row bar, and finally improve the read/write performance of the sliders.

To achieve above objective, a bonding method of row bars comprises step (1), attaching a flexible member on a flat bottom surface of a pressurized member; step (2), applying a wax layer on a support surface of a support device; step (3), disposing a row bar on the support surface with the wax layer; and step (4), controlling the pressurized member to fall down, so as to press and even out the row bar.

Preferably, the step (2) concretely comprises applying the wax layer with a thickness in the range of 0.5 mm˜1.0 mm.

Preferably, the wax layer has a working temperature in the range of 110° C.˜120° C., a melting point in the range of 95° C.˜115° C., a softening point in the range of 100° C.˜115° C., and a melt viscosity in the range of 200˜215.

As a preferable embodiment, the wax layer is made of polyethylene wax.

Preferably, the bottom surface of the pressurized member has a length larger than that of the row bar.

Preferably, the flexible member has a length at least equal to that of the bottom surface.

As another preferable embodiment, he flexible member is made of rubber.

Preferably, the flexible member has a hardness in the range of 70 HA˜80 HA.

Preferably, the method further comprises packaging the pressurized member and the flexible member with an antistatic protective film.

Preferably, the method further comprises connecting a metal member to the pressurized member, thereby increasing pressure to the row bar.

As one more embodiment, the method further comprises supplying a first force so as to lower the pressurized member, terminating the first force once the pressurized member contacts the row bar, and supplying a second force so as to lift the pressurized member.

Preferably, the first force is less than the weight of the pressurized member, and the second force is larger than the weight of the pressurized member.

In comparison with the prior art, the method of the present invention includes applying a wax layer on a support surface of the support device, whose texture is more softer than the glue, and cooling speed is much slower. Thus, when the row bar contacts the wax layer, there is little internal stress generating on the row bar. Moreover, as the flat bottom surface of the pressurized member has a flexible member attached thereon, which also has a softer texture, thus, the pressed row bar will not be damaged and will be evened out without severe bending or deformation. Therefore, the improved row bar with desired bending degree is beneficial to the lapping process. Particularly, the present invention makes the lapping process become easy, and the lapping quality better, which can improve the quality of the sliders produced from the row bar, and finally improve the read/write performance of the sliders.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a simplified diagrammatic view that shows how a wafer to form a row bar conventionally;

FIG. 1b shows a bending status of the row bar after cutting;

FIG. 2 shows a conventional row bar bonding apparatus;

FIG. 3 shows another conventional row bar bonding apparatus;

FIG. 4a shows one diagrammatic view of a row bar bonding apparatus according to one embodiment of the present invention;

FIG. 4b shows another diagrammatic view of the row bar bonding apparatus after the pressurized member falling down along the arrow 39;

FIG. 5 shows the pressurized member of the row bar bonding apparatus as shown in FIG. 4a;

FIG. 6 shows a preferred pressurized member according to another embodiment of the present invention;

FIG. 7 shows a preferred pressurized member according to yet an embodiment of the present invention;

FIG. 8 shows a method of bonding a row bar on the support device according to a first embodiment of the present invention; and

FIG. 9 shows a method of bonding a row bar on the support device according to a second embodiment of the present invention.

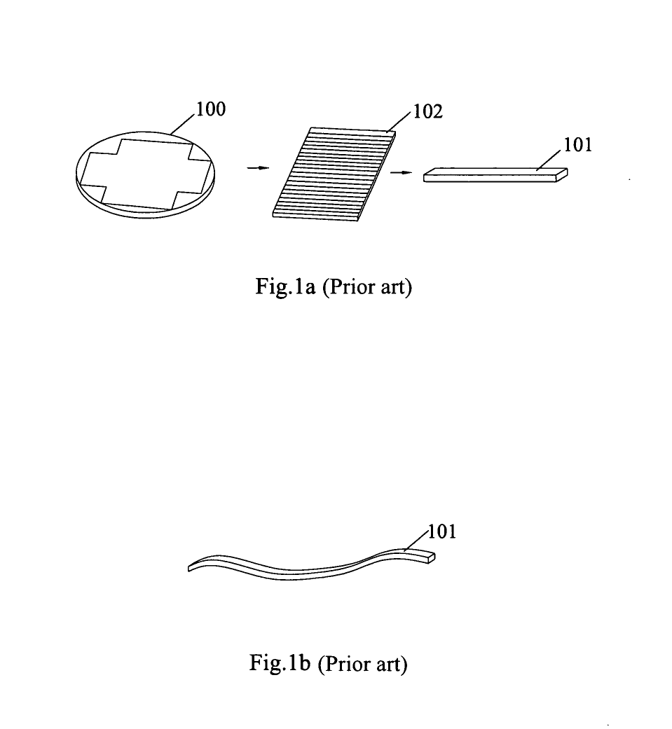

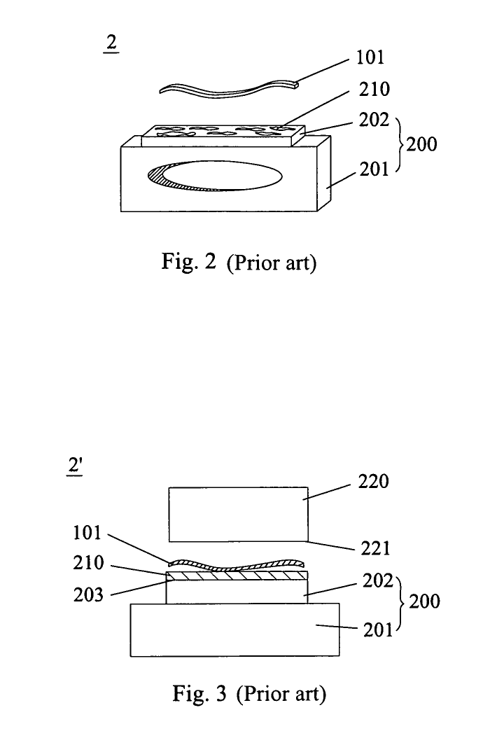

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a bonding method of row bars, which can obtain a desired bending degree for the row bar that is beneficial to the subsequent lapping process, and in turn, improve the quality of the sliders produced from the row bar, and finally improve the read/write performance of the sliders.

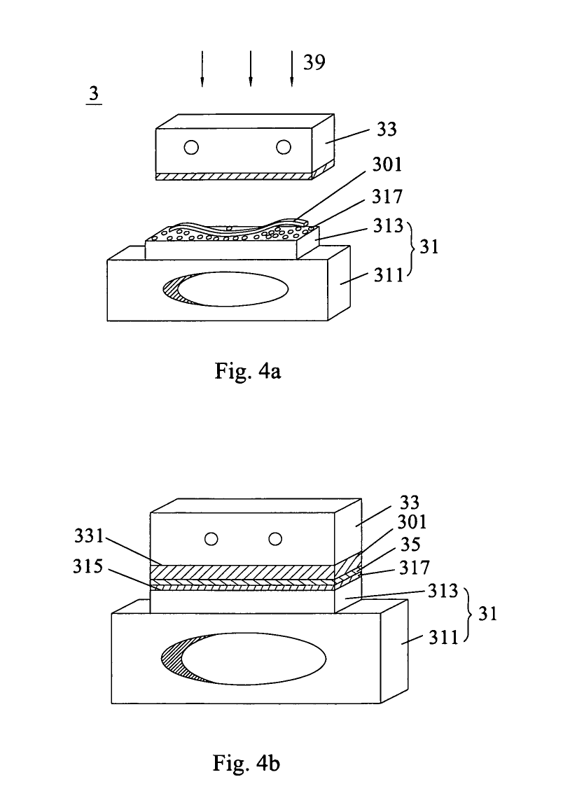

Referring to FIGS. 4a, 4b, according to the present invention, a row bar bonding apparatus 3 includes a support device 31 and a pressurized member 33. Concretely, as shown, the support device 31 includes a base 311 and a supporting step 313 connected thereon for holding a single row bar 301. Within the conception of the present invention, the supporting step 313 has a support surface 315, on which a wax layer 317 is applied while bonding. As a preferable embodiment, the wax layer 317 is made of polyethylene wax with a model of WAX325MP. This polyethylene wax has a melting point in the range of 95° C.˜115° C., such as 106° C., a softening point in the range of 100° C.˜115° C., such as 109° C., a melt viscosity of in the range of 200˜215, such as 205, and a working temperature of 110° C.˜120° C. preferably. More preferably, the thickness of the wax layer 317 applying on the support surface 315 has a range of 0.5 mm˜1.0 mm. The wax layer 317 with such a design can improve the bending degree of the row bar 301 without damage.

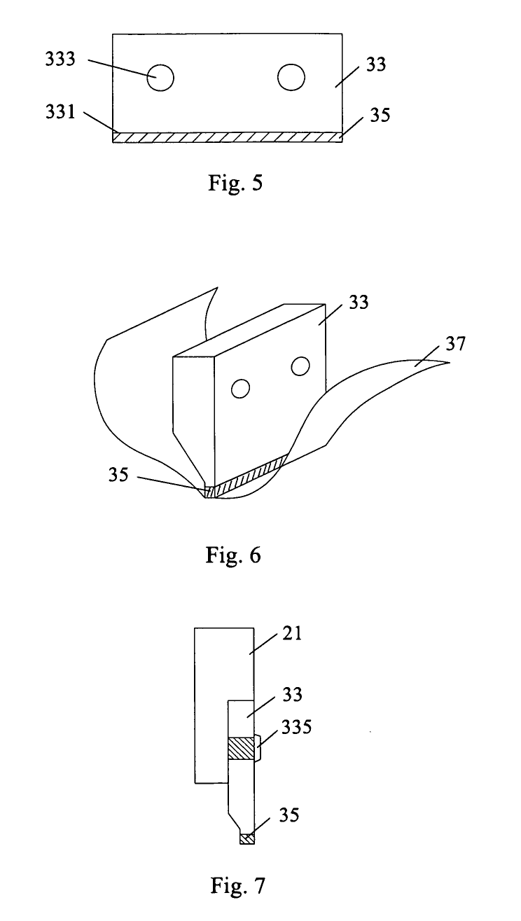

As shown in FIGS. 4b and 5, the pressurized member 33 of the present embodiment is a cube member, which includes a flat bottom surface 331. A flexible member 35 is attached on the bottom surface 331 in this embodiment. Therein, the flexible member 35 has a length at least equal to that of the bottom surface 331, and the bottom surface 331 of the pressurized member 35 has a length larger than that of the row bar 301, so as to press the whole row bar 301 adequately. Preferably, the flexible member 35 is rubber that has a hardness with a range of 70 HA˜80 HA, which has flexibility in a degree. Thus, when the pressurized member 33 with such a flexible member 35 is pressed on the row bar 301, there is little deformation generated on the row bar 301 at instantaneous bonding.

For preventing the flexible member 35 from sticking on the row bar 301 under the heat condition, an antistatic protective film 37 is packaged and wrapped around the pressurized member 33 and the flexible member 35, as shown in FIG. 6. Additionally, the antistatic protective film 37 can prevent the slider made of the row bar 301 from breaking down by the static.

As shown in FIG. 7, the row bar bonding apparatus 3 further comprises a metal member 21 connected with the pressurized member 33, so as to increase pressure to the pressurized member 33. Concretely, two holes 333 are formed on the pressurized member 33, through which the pressurized member 33 connects to the metal member 21 by two screws 335. Preferably, the melt member 21 has a weight of 4.5 kg˜5.0 kg, so as to force the pressurized member 33 to fall down.

The row bar bonding apparatus 3 further includes a control device (not shown in the case) arranged for controlling the falling speed of the pressurized member 33 for pressing the row bar 301. In particularly, the control device provides an upward force with a weight less than that of the pressurized member 33 with the melt member 21 when they fall down to the row bar 301 along the arrow 39, and stops the force until the flexible member 35 contacts with the row bar 301. After the wax layer 317 is cooling for 10 seconds˜15 seconds, supply an upward force with a weight larger than that of the pressurized member 33 with the melt member 21, to make them take off from the row bar 301. In this invention, the force can supply by an electric power system, air pressure system or a hydraulic pressure system and the like. The upward force can slow down the speed of the pressurized member 33 falling, which can prevent the deformation of the row bar 301 caused by the too fast falling.

Comparing with the prior art, the present invention provides a support device has a wax layer applying on the support surface, whose texture is more softer than the glue, and cooling speed is much slower. Thus, when the row bar contacts the wax layer, there is little internal stress generating on the row bar. Moreover, as the flat bottom surface of the pressurized member has a flexible member attached thereon, which also has a softer texture, thus, the pressed row bar will not be damaged and will be evened out without severe bending or deformation. Therefore, the improved row bar with desired bending degree is beneficial to the lapping process. Particularly, the present invention makes the lapping process become easy, and the lapping quality better, which can improve the quality of the sliders produced from the row bar, and finally improve the read/write performance of the sliders.

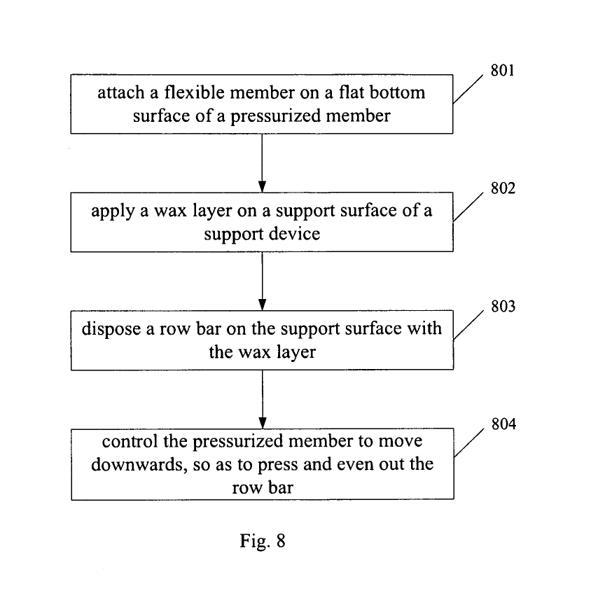

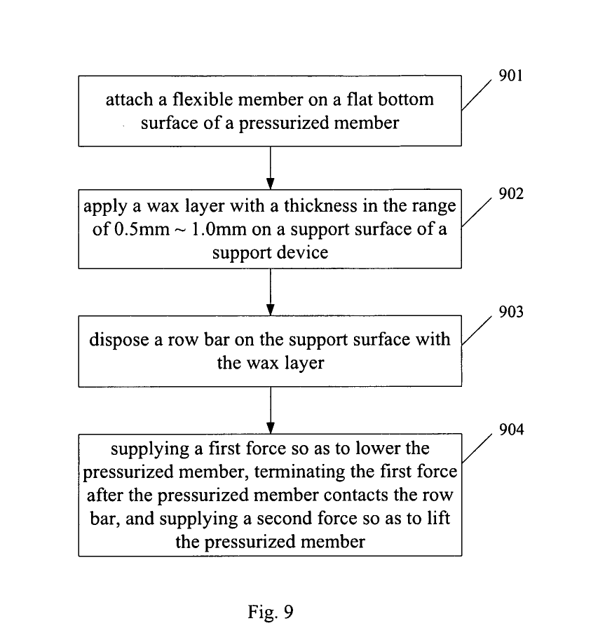

Now a method of bonding a row bar on the support device is described as following referring to FIG. 8.

Step (801), attach a flexible member on a flat bottom surface of a pressurized member;

Step (802), apply a wax layer on a support surface of a support device;

Step (803), dispose a row bar on the support surface with the wax layer;

Step (804), control the pressurized member to move downwards, so as to press and even out the row bar.

Concretely, in the step (801), configure the flexible member having a length at least equal to that of the bottom surface of the pressurized member, and the bottom surface of the pressurized member has a length larger than that of the row bar, so as to press the whole row bar adequately. Preferably, the flexible member is rubber that has a hardness with a range of 70 HA˜80 HA, which has flexibility in a degree. Thus, when the pressurized member 33 with such a flexible member is pressed on the row bar, there is little deformation generated on the row bar at instantaneous bonding.

Preferably, in the step (802) apply the wax layer with a thickness of 0.5 mm˜1.0 mm. And the wax layer is made of polyethylene wax with a model of WAX325MP preferably. This polyethylene wax has a melting point in the range of 95° C.˜115° C., such as 106° C., a softening point in the range of 100° C.˜115° C., such as 109° C., a melt viscosity of in the range of 200˜215, such as 205, and a working temperature of 110° C.˜120° C. preferably. The wax layer with such a design can improve the bending degree of the row bar without damage.

FIG. 9 shows another method of bonding a row bar on the support device according to the present invention.

Step (901), attach a flexible member on a flat bottom surface of a pressurized member;

Step (902), apply a wax layer with a thickness in the range of 0.5 mm˜1.0 mm on a support surface of a support device;

Step (903), dispose a row bar on the support surface with the wax layer;

Step (904), supplying a first force so as to lower the pressurized member, terminating the first force after the pressurized member contacts the row bar, and supplying a second force so as to lift the pressurized member.

Particularly, in the step (904), the first force is an upward force with a weight less than that of the pressurized member when it falls down to the row bar, so as to slow down the falling speed of the pressurized member. After the wax layer is cooling for 10 seconds˜15 seconds, supply the second force with upward direction and with a weight larger than that of the pressurized member with the melt member, to lift them from the row bar. In this invention, the force can supply by an electric power system, air pressure system or a hydraulic pressure system and the like. The first force can slow down the moving speed of the pressurized member, which can prevent the deformation of the row bar caused by the too fast falling.

Using the present method, the bending degree of the row bar is improved, which is beneficial to the subsequent lapping process. Concretely, the wax layer is softer than the glue, and the cooling speed is much slower. Thus, when the row bar contacts the wax layer, there is little internal stress generating on the row bar. Moreover, as the flat bottom surface of the pressurized member has a flexible member attached thereon, which also has a softer texture, thus, the pressed row bar will not be damaged and will be evened out without severe bending or deformation. Therefore, the present invention makes the lapping process become easy, and the lapping quality become better, which can improve the quality of the sliders produced from the row bar, and finally improve the read/write performance of the sliders. Furthermore, the present method is simple and easy to carry on, which reduces the cost of lapping.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A bonding method of row bars, wherein comprising:
step (1), attaching a flexible member on a flat bottom surface of a pressurized member;
step (2), applying a wax layer on a support surface of a support device;
step (3), disposing a row bar on the support surface with the wax layer; and
step (4), controlling the pressurized member to fall down, so as to press and even out the row bar.

2. The bonding method according to claim 1, wherein the step (2) concretely comprises applying the wax layer with a thickness in the range of 0.5 mm˜1.0 mm.

3. The bonding method according to claim 1, wherein the wax layer has a working temperature in the range of 110° C.˜120° C., a melting point in the range of 95° C.˜115° C., a softening point in the range of 100° C.˜115° C., and a melt viscosity in the range of 200˜215.

4. The bonding method according to claim 1, wherein the wax layer is made of polyethylene wax.

5. The bonding method according to claim 1, wherein the bottom surface of the pressurized member has a length larger than that of the row bar.

6. The bonding method according to claim 1, wherein the flexible member has a length at least equal to that of the bottom surface.

7. The bonding method according to claim 1, wherein the flexible member is made of rubber.

8. The bonding method according to claim 1, wherein the flexible member has a hardness in the range of 70 HA˜80 HA.

9. The bonding method according to claim 1, wherein further comprises packaging the pressurized member and the flexible member with an antistatic protective film.

10. The bonding method according to claim 1, wherein further comprises connecting a metal member to the pressurized member, thereby increasing pressure to the row bar.

11. The bonding method according to claim 1, wherein the step (4) comprises supplying a first force so as to lower the pressurized member, terminating the first force once the pressurized member contacts the row bar, and supplying a second force so as to lift the pressurized member.

12. The bonding method according to claim 11, wherein the first force is less than the weight of the pressurized member, and the second force is larger than the weight of the pressurized member.
